(19) United States
(12) Patent Application Publication
(10) Pub. No.: US 2015/0105196 A1
(43) Pub. Date: Apr. 16, 2015

(54) DAMPER PULLEY

(71) Applicants: Kia Motors Corporation, Seoul (KR); Hyundai Motor Company, Seoul (KR)

(72) Inventor: Jae Kwon LEE, Whasung-Si (KR)

(73) Assignees: Kia Motors Corporation, Seoul (KR); Hyundai Motor Company, Seoul (KR)

(21) Appl. No.: 14/145,372

(22) Filed: Dec. 31, 2013

(30) Foreign Application Priority Data
Oct. 14, 2013 (KR) 10-2013-0122239

(51) Int. Cl. F16H 55/36

(52) U.S. Cl. CPC F16H 55/36
USPC 474/94

(57) ABSTRACT

A damper pulley may include a damper hub part coupled to a crank shaft rotated upon receiving rotary driving force of an engine such that the damper hub part is integrally rotated with the crank shaft and a damper pulley part coupled to the damper hub part such that the damper pulley part is integrally rotated with the damper hub part. A power transmission unit is connected to the damper pulley part. The damper hub part may be made of a material comprising forged aluminum and the damper pulley part may be made of a material comprising a metal. The damper pulley has a reduced overall weight, and vibrations and impact can be reduced to enhance ride comfort.

### CROSS-REFERENCE TO RELATED APPLICATION

The present application claims priority of Korean Patent Application Number 10-2013-0122239 filed Oct. 14, 2013, the entire contents of which application are incorporated herein for all purposes by this reference.

### BACKGROUND OF INVENTION

1. Field of Invention

The present invention relates to a damper pulley and, more particularly, to a damper pulley including a damper hub part made of forged aluminum or a material comprising forged aluminum and a hub ring and a damper pulley part made of cast iron or a material comprising cast iron.

2. Description of Related Art

In general, a damper pulley is directly connected to and installed in a crank shaft rotationally driven by an engine such that it is integrally rotated therewith in order to directly receive rotary driving force (or rotary power) from the crank shaft. The damper pulley serves to transmit rotary driving force of an engine transmitted from the crank shaft to auxiliary machinery such as a water pump, a power steering device, an air-conditioner, and the like.

FIG. 1 illustrates an example of a related art damper pulley. A damper pulley 100 includes a damper hub part 110 into which a front end portion of a crank shaft 200 rotationally driven by an engine is inserted so as to be integrally rotated.

The damper hub part 110 includes a boss 112 into which the front end portion of the crank shaft 200 is insertedly installed and a hub flange 114 having a diameter greater than that of the boss 112 and integrally formed with the boss 112.

A first rubber damper 120 generally made of rubber is attached to an inner circumferential surface of the hub flange 114 to absorb and reduce vibrations or impact, and an inertia ring 130 having an annular shape is attached to an inner circumferential surface of the first rubber damper 120 to provide inertial mass.

A damper pulley part 140 having a diameter greater than that of the hub flange 114 is disposed in an outer side of the hub flange 114. The damper pulley part 140 has a substantially cylindrical shape, covering the hub flange 114 insertedly positioned therein.

An inner diameter of the damper pulley part 140 is greater than an outer diameter of the hub flange 114, and a second rubber damper 150 generally made of rubber to cope with a change in external force such as vibrations, impact, or the like, is interposed between an inner circumferential surface of the damper pulley part 140 and an outer circumferential surface of the hub flange 114.

Namely, the inner circumferential surface of the damper pulley 140 is attached to an outer circumferential surface of the second rubber damper 150, and the outer circumferential surface of the hub flange 114 is attached to an inner circumferential surface of the second rubber damper 150.

A belt recess 142 is formed on the outer circumferential surface of the damper pulley part 140, and a belt may be wound on the belt recess 142 to transmit rotary driving force of the engine received from the crank shaft 200 to a different device therethrough. A plurality of belt recesses 142 may be formed on the outer circumferential surface of the damper pulley part 140 such that they are inwardly depressed, and in general, the plurality of belt recesses may have a V-like shape.

An oil seal 160 is installed on an outer circumferential surface of the boss 112 in order to prevent engine oil from being leaked outwardly, and a cover 170 is installed in an outer side of the oil seal 160 to protect the oil seal 160 from an external environment.

The damper hub part 110, the damper pulley part 140, and the inertia ring 130 are generally made of cast iron (FC25) having tensile strength of approximately 250 MPa.

However, since the related art damper pulley is largely made of iron cast, it is disadvantageous to vibrations and impact and increases weight of a vehicle, degrading fuel efficiency.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a damper pulley having advantages of enhancing fuel efficiency by forming a damper hub part with a light metal material to reduce an overall weight, and enhancing ride comfort by reducing vibrations and impact.

Various aspects of the present invention provide a damper pulley including: a damper hub part coupled to a crank shaft rotated upon receiving rotary driving force of an engine such that the damper hub part is integrally rotated with the crank shaft, and made of a material comprising forged aluminum; and a damper pulley part coupled to the damper hub part such that the damper pulley part is integrally rotated with the damper hub part, wherein the damper pulley part is made of a material comprising a metal and to which a power transmission unit is connected.

The forged aluminum may have tensile strength equal to or greater than 300 MPa. The forged aluminum may have yield strength equal to or greater than 280 MPa.

The damper hub part may have a boss coupled to the crank shaft, and an outer circumferential surface of the boss in an outer side of the boss in a radial direction may be hard-anodized. An oil seal is installed in the outer circumferential surface of the boss, and a cover may be installed in an outer side of the oil seal in the radial direction. Rockwell hardness of the outer circumferential surface of the boss may be equal to or greater than HRc36.

The damper pulley part may be made of a material comprising cast iron.

The damper hub part may include a boss coupled to the crank shaft such that the boss is integrally rotated with the crank shaft and a cylindrical hub flange having a diameter greater than that of the boss and integrally formed with the boss. A first rubber damper may be attached to an inner circumferential surface of the hub flange. An inertial ring may be attached to an inner circumferential surface of the first rubber damper. The damper pulley part may have a cylindrical shape covering the hub flange which is insertedly positioned in an inner side thereof. A second rubber damper may be interposed between an inner circumferential surface of the damper pulley part and an outer circumferential surface of the hub flange. A plurality of belt recesses may be formed on the damper pulley part and depressed inwardly in a radial direction and have a V-like shape, with which the power transmission unit is coupled.

In the case of the damper pulley according to various aspects of the present invention, since the damper pulley part coupled to the crank shaft, which is rotated upon receiving rotary driving power from an engine, to receive rotary driving force of an engine therefrom is made of forged aluminum or a material comprising forged aluminum, an overall weight of the damper pulley is reduced, enhancing fuel efficiency of a vehicle.

In addition, since the damper pulley is lightweight, vibrations and impact are reduced when the damper pulley is operated, enhancing ride comfort of a vehicle.

Also, the damper hub part made of forged aluminum or a material comprising forged aluminum has high modulus of elasticity and rigidity, minimizing barreling deformation due to high axial force, and the outer circumferential surface thereof in which the oil seal is installed is hard-anodized to have increased hardness, enhancing durability while reducing abrasion, and also enhancing adhesion with the oil seal to reduce leakage of engine oil.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a partially cutaway perspective view illustrating a crank shaft coupled to a damper pulley according to the related art.

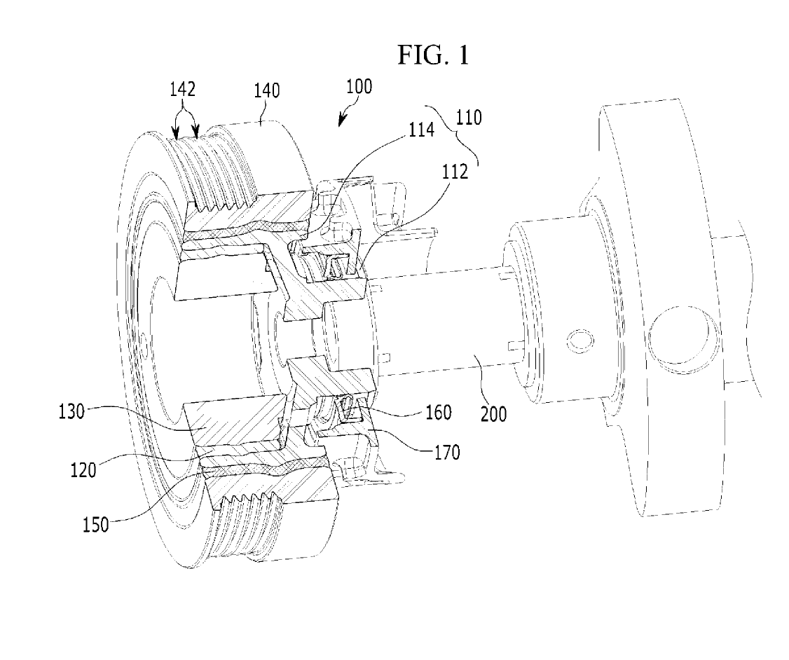

FIG. 2 is a partially cutaway perspective view illustrating an exemplary crank shaft coupled to a damper pulley according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

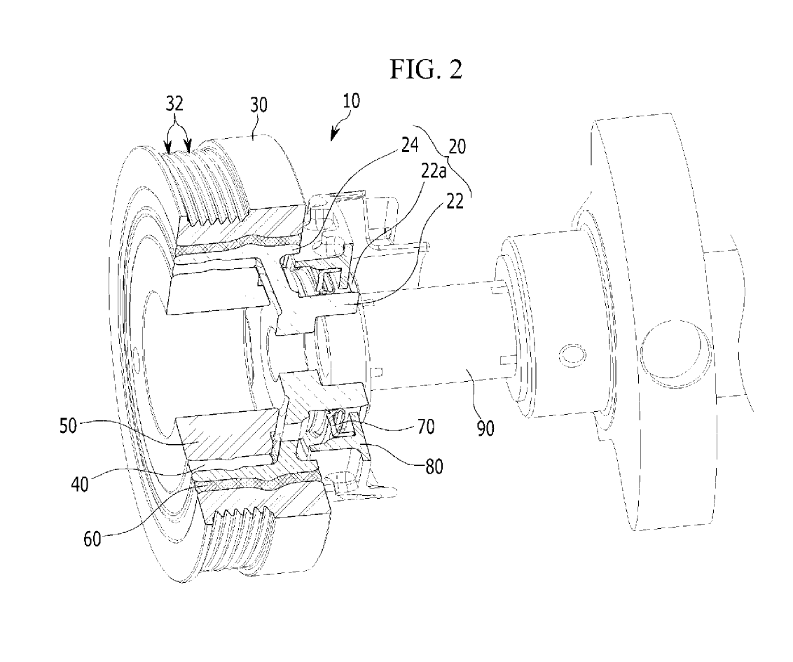

Referring to FIG. 2, a damper pulley 10 according to various embodiments of the present invention largely serves to transmit rotary driving force of an engine to auxiliary machinery such as a water pump, a power steering device, an air-conditioner, and the like. In order to transmit rotary driving force of the engine outwardly, a crank shaft 90 is installed to receive rotary driving force of the engine in a cylinder block constituting the engine and the damper pulley 10 according to various embodiments of the present invention is connected to the crank shaft 90 such that it is integrally rotated therewith.

The damper pulley 10 according to various embodiments of the present invention may include a damper hub part 20 directly connected to the crank shaft 90 in order to receive rotary driving force from the crank shaft 90 and a damper pulley part 30 having a power transmission unit such as a belt, or the like, in order to receive rotary driving force from the damper hub part 20 and supply the same to an external device.

The damper hub part 20 may include a boss 22 to which a front end portion of the crank shaft 90 is insertedly coupled and a cylindrical hub flange 24 having a diameter greater than that of the boss 22 and integrally or monolithically formed with the boss 2.

A first rubber damper 40, generally made of rubber or the like, may be attached to an inner circumferential surface of the hub flange 24 in order to absorb and reduce vibrations or impact, and an inertial ring 50, having an annular shape, may be attached to an inner circumferential surface of the first rubber damper 40 in order to provide inertial mass thereto.

The damper pulley part 30 may be disposed in an outer side of the hub flange 24 and having a diameter greater than that of the hub flange 24. The damper pulley part 30 may have a substantially cylindrical shape to cover the hub flange 24 which is insertedly positioned in an inner side thereof. Namely, the damper pulley part 30 may have a cylindrical shape with both sides thereof opened.

An inner diameter of the damper pulley part 30 may be greater than an outer diameter of the hub flange 24, and a second rubber damper 60, generally made of rubber or the like, may be interposed between an inner circumferential surface of the damper pulley part 30 and an outer circumferential surface of the hub flange 24 in order to cope with a change in external force such as vibrations, impact, or the like.

Namely, the inner circumferential surface of the damper pulley part 30 is attached to an outer circumferential surface of the second rubber damper 60, and the outer circumferential surface of the hub flange 24 may be attached to an inner circumferential surface of the second rubber damper 60.

The belt recesses 32 may be formed on the outer circumferential surface of the damper pulley part 30, and a power transmission unit such as a belt, or the like, is installed to be wound around the belt recesses 32 in order to transmit rotary driving force of the engine transmitted from the crank shaft 90 to a different device therethrough. A plurality of belt recesses 32 may be formed to be depressed inwardly from the outer circumferential surface of the damper pulley part 30, and may generally have a V-like shape.

An oil seal 70 may be installed in the outer circumferential surface of the boss 22 in order to prevent leakage of engine oil to the outside. A cover 80 is installed in an outer side of the oil seal 70 in a radial direction to protect the oil seal 80 from an ambient environment.

The damper pulley part 30 and the inertial ring 50 may be made of a material or a metal having tensile strength of approximately 250 MPa, in particular, in some embodiments, made of cast iron (e.g., FC25) or a material comprising cast iron (e.g., FC25).

The damper hub part 20 may be made of forged aluminum or a material comprising forged aluminum in order to reduce weight. In particular, in some embodiments, the damper hub part 20 may be made of forged aluminum or a material comprising forged aluminum having tensile strength equal to or greater than 300 MPa and yield strength equal to or greater than 280 MPa.

When the damper hub part 20 is made of forged aluminum or a material comprising forged aluminum, weight may be more effectively reduced in comparison to a case in which the damper hub part 20 is made of cast iron.

Also, in order to enhance abrasion resistance by increasing hardness of the outer circumferential surface 22a of the boss 22 in which the oil seal 70 is installed, the outer circumferential surface 22a of the boss 22 may be hard-anodized to form an aluminum oxide coating layer. In particular, in some embodiments, the outer circumferential surface 22a of the boss 22 may be coated with an aluminum oxide coating layer to have hardness equal to or greater than HRc36 of Rockwell hardness.

When the outer circumferential surface 22a of the boss 22 is coated with an aluminum oxide coating film, hardness thereof is increased, and although the damper pulley is rotated at a high speed in a state in which the oil seal 70 is installed in the outer circumferential surface 22a, surface abrasion due to the oil seal 70 can be reduced to enhance installation characteristics and air-tightness of the oil seal 70, thus effectively preventing leakage of engine oil.

For convenience in explanation and accurate definition in the appended claims, the terms “inner” or “outer”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A damper pulley comprising:
a damper hub part coupled to a crank shaft rotated upon receiving rotary driving force of an engine such that the damper hub part is integrally rotated with the crank shaft, and made of a material comprising forged aluminum; and
a damper pulley part coupled to the damper hub part such that the damper pulley part is integrally rotated with the damper hub part, wherein the damper pulley part is made of a material comprising a metal and to which a power transmission unit is connected.

2. The damper pulley of claim 1, wherein the forged aluminum has tensile strength equal to or greater than 300 MPa.

3. The damper pulley of claim 1, wherein the forged aluminum has yield strength equal to or greater than 280 MPa.

4. The damper pulley of claim 1, wherein the damper hub part has a boss coupled to the crank shaft, and an outer circumferential surface of the boss in an outer side of the boss in a radial direction is hard-anodized.

5. The damper pulley of claim 4, wherein an oil seal is installed in the outer circumferential surface of the boss, and a cover is installed in an outer side of the oil seal in the radial direction.

6. The damper pulley of claim 4, wherein Rockwell hardness of the outer circumferential surface of the boss is equal to or greater than HRc36.

7. The damper pulley of claim 1, wherein the damper pulley part is made of a material comprising cast iron.

8. The damper pulley of claim 1, wherein:
the damper hub part comprises a boss coupled to the crank shaft such that the boss is integrally rotated with the crank shaft and a cylindrical hub flange having a diameter greater than that of the boss and integrally formed with the boss,
a first rubber damper is attached to an inner circumferential surface of the hub flange,
an inertial ring is attached to an inner circumferential surface of the first rubber damper,
the damper pulley part has a cylindrical shape covering the hub flange which is insertedly positioned in an inner side thereof,
a second rubber damper is interposed between an inner circumferential surface of the damper pulley part and an outer circumferential surface of the hub flange, and
a plurality of belt recesses are formed on the damper pulley part and depressed inwardly in a radial direction and have a V-like shape, with which the power transmission unit is coupled.
